(19) United States
(12) Patent Application Publication
(10) Pub. No.: US 2014/0122173 A1
(43) Pub. Date: May 1, 2014

(54) ESTIMATING SEMI-PARAMETRIC PRODUCT DEMAND MODELS

(71) Applicant: HEWLETT-PACKARD DEVELOPMENT COMPANY, L.P., Houston, TX (US)

(72) Inventors: Jianqiang Wang, Mountain View, CA (US); Kay-Yut Chen, Santa Clara, CA (US); Guillermo Gallego, Waldwick, NJ (US); Ruxian Wang, East Palo Alto, CA (US); Jose Luis Beltran Guerrero, Mountain View, CA (US); Shailendra K. Jain, Cupertino, CA (US)

(73) Assignee: HEWLETT-PACKARD DEVELOPMENT COMPANY, L.P., Houston, TX (US)

(21) Appl. No.: 13/660,286

(22) Filed: Oct. 25, 2012

(51) Int. Cl. G06Q 30/02

(52) U.S. Cl. 705/7.31

(57) ABSTRACT

Methods, systems, and computer-readable and executable instructions are provided for estimating semi-parametric product demand models. Estimating a semi-parametric product demand model can include identifying a set of products from input market sales data, analyzing the market sales data to determine a relationship between a plurality of factors of the set of products, and estimating the semi-parametric product demand model based on the determined relationship using iterative estimation of a plurality of incremental data trees.

### BACKGROUND

Manufacturers are driven to compete in a marketplace in order to obtain a desired profit and/or target a market share. Pressure to compete can cause a product on the market to have numerous model and brand options. Factors of each model and/or brand option can be used to drive consumer and/or marketplace demand in the manufacturer's derived direction.

### BRIEF DESCRIPTION OF THE DRAWINGS

FIG. 1 is a flow chart illustrating an example of a method for estimating a semi-parametric product demand model according to the present disclosure

FIG. 2 illustrates an example of a boosted data tree structure according to the present disclosure.

FIG. 3 is a diagram illustrating an example system including a computing device according to the present disclosure.

### DETAILED DESCRIPTION

Estimating market demand for a product can be important, in some instances, to firms (e.g., manufacturers, companies, and retailers). For example, a manufacturer and/or retailer may intend to understand price sensitivity of consumers of the manufacturer and/or retailer's products in order to determine pricing of the products.

To attract customers and earn profits, firms may offer multiple differentiated substitutable products and adopt different pricing strategies. Customers may choose among a variety of competing goods based on features, quality, brand, price, etc. Customer preferences for a particular model and/or brand can be important factors in driving demand in a desired direction.

Consumer preferences for a product can depend upon customer preference for features and/or attributes of the product, price, and other products that may be on the market. Predicting demand for a product can be difficult, for example, because of large amounts of sales data and a large mixture of features and/or attributes that can require a high level of processing to analyze. Further, predicting demand for a product can be difficult, in some cases, due to the non-linear and/or non-additive nature of consumer preference.

Estimating a market demand model for a product, in accordance with some examples of the present disclosure, can include building a semi-parametric product demand model that considers non-linear and/or non-additive consumer preference about attributes and/or features, price sensitivity, and competitive effects. A semi-parametric model, as used herein, can include modeling non-parametric components (e.g., factors and/or relationships) in combination with parametric components. Each product in a set of products on the market can have a specified utility (e.g., customer valuation of the product) based on the brand, attribute, price, and other factors. A customer can be assumed to choose the product with the highest utility to purchase. Thereby, a product purchased by a customer can include a product with the highest utility among all products on the market.

In some examples of the present disclosure, a set of products identified from input market sales can be analyzed to determine a relationship between a plurality of factors of the set of products. The relationship, for instance, can be represented by a tree-shaped object, called a data tree. For example, the data tree can partition products in the set of products into homogeneous groups based on utility functions and can split the groups based on differing features.

A data tree can include a number of nodes connected to form a number of node paths, wherein one of the nodes is designated as a root node. A root node can include, for example, a topmost node in the tree. Each individual node within the number of nodes can represent a data point. The number of node paths can show a relationship between the number of nodes. For example, two nodes that are directly connected (e.g., connected with no nodes between the two nodes) can have a closer relationship compared to two nodes that are not directly connected (e.g., connected with a number of nodes connected between the two nodes).

Various types of data can be represented utilizing a tree-shaped data model. For example, with product customization in a number of industries, a customer can make decisions regarding a number of features of the product. For each decision by the customer, a different set of features can become available. For example, if the customer makes a decision on a particular model, the number of color choices for the particular model can be different compared to a different model. In this example, each decision can represent a node on a particular level. After completion of the product customization, the number of nodes can be connected to form a data path and/or data tree. In this example, the data path and/or data tree can be considered a single data point. If a different customer went through the product customization, the different customer decisions can be connected to form a different data path and/or data tree.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

The figures herein follow a numbering convention in which the first digit or digits correspond to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

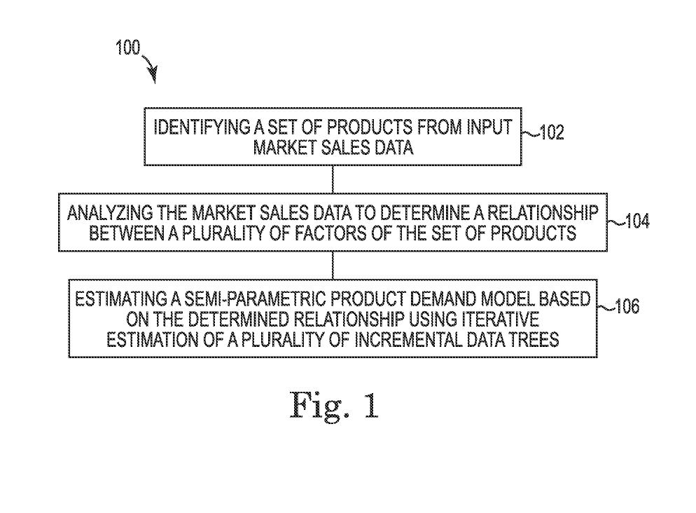

FIG. 1 is a flow chart illustrating an example of a method 100 for estimating a semi-parametric product demand model according to the present disclosure. Examples of the present disclosure provide that the method 100 is a computer implemented method. For example, the method 100 may be performed in association with a system and/or computing device (e.g., a memory resource coupled to a processing resource), as discussed herein.

A semi-parametric product demand model can include a prediction of a customer evaluation of a set of products that includes a plurality of data trees representing non-linear interactions between factors of the set of products. Factors, as used herein, can include attributes and/or features available in the set of products. Example factors can include pricing, brand, time, geographic location, among many other factors that may contribute to consumers' evaluation of a product.

At 102, the method 100 can include identifying a set of products from input market sales data. The input market sales data can include an aggregated set of market sales data. The aggregated market sales data can include applicable markets and an offer set in the market (e.g., set of products in the applicable markets and factors of the set of products). For instance, the market sales data can include brands of products, country, region, attributes, time, channel, price, and sales volume, among other information and/or data. The set of products can include a plurality of products available for a customer to choose among for purchasing. The applicable markets, in various examples, can be user specified and/or a predetermined consideration set (e.g., user configurable). The user can include a marketing manager and/or person associated with a firm.

In some examples, method 100 can include aggregating historical market sales data. For instance, the historical market sales data can be gathered and organized. Information regarding the product's price, similar product's prices, competitor's prices, brands, product features, etc. can be gathered, for example. The information can be gathered, in various examples, from an outside source and/or internally by a firm.

At 104, the method 100 can include analyzing the market sales data to determine a relationship between a plurality of factors of the set of products. The relationship can include a linear model relationship, a linear multinomial logit (MNL) model, and/or a semi-parametric model (e.g., choice model). Such a relationship can be determined, for instance, using a MNL model in combination with a semi-parametric choice model, such as a varying coefficient linear model, a functional-coefficient choice model, and/or a partially linear choice model, as discussed herein. A choice model, as used herein, can include a model of a decision process of an individual and/or a segment of a particular context (e.g., probabilistic predictions about human decision making behavior).

A semi-parametric choice model and/or model, as used herein, can include a model with a combination of non-parametric components (e.g., factors and/or relationships) and parametric components. Thereby, a semi-parametric choice model and/or model can be non-linear and/or non-parametric. A non-parametric model can include modeling non-parametric relationship(s) between variables and/or a sub-set of variables with parametric assumptions about the distribution of model residuals.

A MNL model, as used herein, can include a discrete choice model to be used to predict probabilities of different possible outcomes of a categorically distributed dependent variable, given a set of independent variables. A MNL model can be derived from an underlying random utility model, which can be based on a probabilistic model of individual customer utility, which can model customers with inherently unpredictable behavior, and as a result, can show probabilistic tendency for a customer to prefer one alternative to another in a set of alternative (e.g., relevant alternative) choices, including a non-alternative choice. For example, if there is a random part of customers' utility, or a firm has only probabilistic information on the utility function of any given customer, the MNL model can describe customers' purchase behavior. Utility, as used herein, can include an amount of customer desire that a product will satisfy, at a certain place and time (e.g., a customer attraction and/or satisfaction of a product).

For example, each product in the set of products can have a utility value. A utility value, as used herein, can include an estimation of customer valuation of the product and/or an amount of customer desire that a product will satisfy, at a certain place and time. A consumer can be assumed to buy a product with the highest utility value among the set of products in the market. Utility, for example, can depend upon brand, attribute, and/or price, among other factors.

The determined relationship of the plurality of factors can, for instance, include a non-linear and/or non-additive relationship. A non-linear relationship can include a change in feature(s) affecting utility of a product in a non-linear manner. A non-additive relationship can include, for instance, the combination of two or more features not adding up to the sum of each individual feature's utility (e.g., utility of two features is greater than or less than the utility of a product with the two features).

For instance, the relationship between the plurality of factors can include a tree data structure that groups similar utility functions (e.g., utility values) together and splits the groups based on the attributes and/or features of the set of products. As an example, consider a market with K products in competition. The market can include a specific product market (e.g., a mobile computer market) in a geographic location over a period of time, an online market for non-perishable goods, or a non-purchase option, for example. Based on input aggregate sales data, a sales volume of the i-th product can be denoted as nᵢ, where i=1, . . . , K. The total market sales can be denoted as:

N=Σᵢ₌₁^{K}nᵢ,

Further, (s′ᵢ, x′ᵢ, nᵢ) can denote a vector of the measurements of product i. For instance, sᵢ=(sᵢ₁, sᵢ₂, . . . , s_{iq})′ can include product attributes, brand, and channel information, whose effect on utility has an unknown functional form. x′ᵢ can include a vector of linear predictors, such as, xᵢ=(xᵢ₁, xᵢ₂, . . . , xᵢₚ)′. Linear predictors can include factors that consist of a linear effect, such as price and/or other predictors.

The utility of a product can capture the overall attractiveness given attributes, brand, price, and/or other factors relating to a customers shopping experience. The utility can be positively correlated with product attributes, but can be adversely affected by price. For instance, the utility of the i-th product can be denoted as:

uᵢ=fᵢ+εᵢ,

wherein fᵢ can include a function of sᵢ and xᵢ. For example, εᵢ can denote a random noise term not captured by auxiliary variables, arising from the idiosyncratic errors in consumers' decision making, For instance, εᵢ can be independent and identically distributed with a standard Gumbel distribution. A Gumbel distribution can include a model of the distributions of a maximum and/or minimum of a number of samples of various distributions. Thereby, a utility maximization principle can lead to a choice probability for an i-th product of:

$${p}_{i} = \frac{exp ( {f}_{i} )}{{\sum }_{i = 1}^{K} exp ( {f}_{i} )} . \qquad ( 1 )$$

A vector of sales volume (nᵢ, . . . , n_{M}) can follow a multinomial distribution with N trials and probabilities (p₁, . . . , p_{K}) as defined by Equation 1. A model, resulting from Equation 1, can include a multinomial logit (MNL) model. A utility function in a MNL model can be exponential and can be generalized to arbitrary utility functions. For instance, g(·) can denote the utility function (e.g., customer attraction) that can be a monotone function that takes values on (0, + ∞). Under the utility function g(·), the choice probability of product i can be:

$${p}_{i} = \frac{g ( {f}_{i} )}{{\sum }_{i = 1}^{K} g ( {f}_{i} )} . \qquad ( 2 )$$

To estimate the utility functions, the data likelihood can be maximized and/or −2 log L can be minimized wherein L can denote a likelihood function. Alternatively, J(f) can be used, which differs from −2 log L by a constant:

$$J ( f ) = - 2 {\sum }_{i = 1}^{K} {n}_{i} \{ log ( g ( {f}_{i} ) ) \} + 2 N log \{ {\sum }_{i = 1}^{K} g ( {f}_{i} ) \} , \qquad ( 3 )$$

wherein f=(f₁, . . . fₖ)′ can denote a vector of product utilities.

Product utilities can, for instance, be determined using a semi-parametric model of utility (e.g., semi-parametric model). A semi-parametric model can include a model with parametric components and nonparametric components. Semi-parametric models of utility can, for instance, result in choice models. Two examples of choice models can include a functional-coefficient choice model and a partially linear choice model (e.g., semi-parametric choice model).

A functional-coefficient choice model can, for instance, be used to determine a relationship between a plurality of factors of a set of products. A functional-coefficient choice model can, for example, specify a utility function as:

fᵢ=x′ᵢ β(sᵢ), (4)

which can include a linear function of x with coefficients depending on s. The function of Equation 4 can be reduced to a globally linear function by removing the dependence of the coefficients on s. Removing the dependency of coefficients on s can result in a linear choice model.

As an example, removing the dependency of coefficients on s to create a resulting linear choice model, in a simple case, when xᵢ=(1, xᵢ)′ and where xᵢ is the price of product i, the utility function can become β₀ (sᵢ)+β₁ (sᵢ) xᵢ. β₀ can denote base utility of a product and β₁ can denote price elasticity. Thereby, both the base utility and price elasticity can depend on (sᵢ) and the elasticity can be constant when (sᵢ) is fixed. The function-coefficient choice model can include:

$$J ( f ) = - 2 {\sum }_{i = 1}^{K} {n}_{i} \{ log ( g ( {x}_{i}^{′} β ( {s}_{i} ) ) ) \} + 2 N log \{ {\sum }_{i = 1}^{K} g ( {x}_{i}^{′} β ( {s}_{i} ) ) \} , \qquad ( 5 )$$

wherein Equation 5 can include a relationship between a plurality of factors of the set of products.

Alternatively and/or in addition, a relationship between a plurality of factors can be determined using a partially linear choice model. A partially linear choice model, as used herein, can include a semi-parametric choice model. A partially linear choice model can, for example, specify a utility function as:

fᵢ=β₀(sᵢ)+x′ᵢ β, (6)

wherein β₀ (sᵢ) can include a nonparametric term and x′ᵢβ can include a linear term. For instance, a linear term can include linear predictors. An example of linear predictors can include price. When price is the only linear predictor, the resulting model can consist of a base utility that is a non-parametric function of attributes and globally constant price elasticity. The entire partially linear choice model can include:

$$J ( f ) = - 2 {\sum }_{i = 1}^{K} {n}_{i} \{ log ( g ( {β}_{0} ( {s}_{i} ) + {x}^{′} β ) ) \} + 2 N log \{ {\sum }_{i = 1}^{K} g ( {β}_{0} ( {s}_{i} ) + {x}^{′} β ) \} , \qquad ( 7 )$$

wherein Equation 7 can include a relationship between a plurality of factors of the set of products. The relationship resulting from Equation 7 can include a semi-parametric relationship, for instance.

At 106, the method 100 can include estimating a semi-parametric product demand model based on the determined relationship using iterative estimation of a plurality of incremental data trees. The semi-parametric product demand model, as used herein, can include a model that outputs an estimate of customer valuation of the set of products. The incremental data trees can, for instance, represent non-linear interactions and/or relationships between factors of the set of products. Thereby, incremental data trees can be non-parametric.

For instance, customer valuation can include a product-specific utility function, brand value calculation, price sensitivity, and/or ranking of attributes of the set of products, among other outputs. A product-specific utility function can include a function that outputs the effect on demand for a product if price and/or an attribute (e.g., a factor) is changed. For instance, a user can manually change a factor of a product to observe changes in demand for the product based on the estimated semi-parametric product demand model. A brand value calculation can include a numerical value of each brand in the market for a product. Price sensitivity can include a degree to which a product's price affects customers' purchasing behavior. Price sensitivities can be against various dimensions, such as brand, time, and channel, for instance. Ranking of attributes can include an importance of attributes in a customer's purchase decision and can include a chart (e.g., isotherm chart, bar graph, pie chart, etc.)

Estimating a semi-parametric product demand model based on the determined relationship using iterative estimation of a plurality of incremental data trees can include boosting a choice model (e.g., functional-coefficient choice model and/or partially linear choice model). Each iteration of a plurality of incremental data trees can include calculating a number of residuals from a current product demand model (e.g., the last model), fitting a regression tree to predict the residuals, and adding the regression tree (e.g., a new tree) to the current product demand model (e.g. to create a revised current product demand model and/or the estimated semi-parametric product demand model), for example. The incremental data trees can be calculated and/or estimated, in some examples of the present disclosure, using a varying-coefficient regression model and/or a regression data tree.

A residual, as used herein, can include a partition of factors that may not have been considered in the previous product demand model (e.g., data tree structure). For instance, a residual can include a partition and/or splitting of a group of factors on a data tree structure. The residuals can be fit to the current demand model, for example, using a Partitioned Regression (PartReg) function and/or a Classification and Regressions Tree (CART)™ function, as described herein. The residuals can, for instance, include partition and/or splitting based on features of the set of products.

In various examples of the present disclosure, a semi-parametric product demand model can be estimated based on a suite of semi-parametric choice models. For instance, the relationship between the plurality of factors can include a semi-parametric relationship determined using a partially linear choice model. The partially linear choice model can be boosted using a varying-coefficient regression model to iteratively estimate a plurality of incremental data tress (e.g., non-parametric incremental data trees). The incremental data trees can be fit to the current demand model using a PartReg function and/or CART™ function.

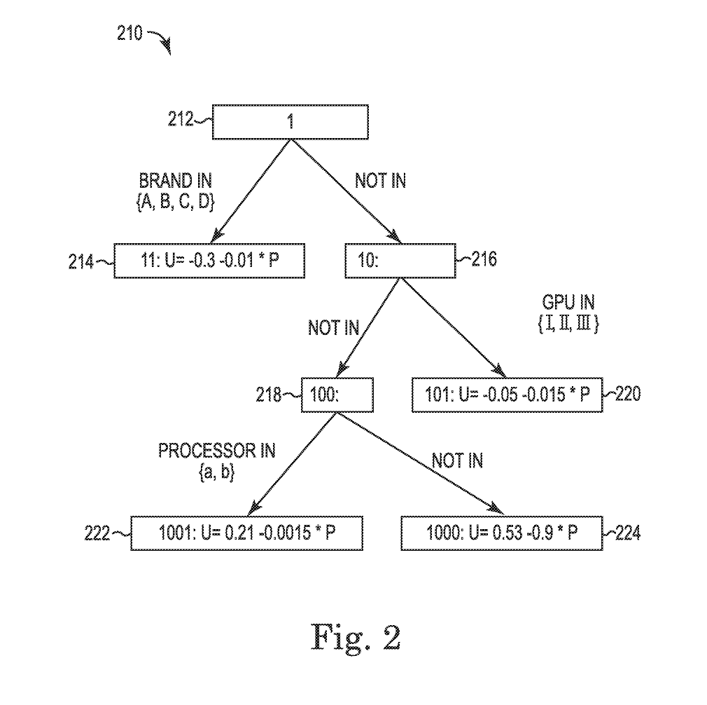

FIG. 2 illustrates an example of a boosted data tree structure 210 according to the present disclosure. A data tree structure can be formed using a semi-parametric choice model, such as a functional-coefficient choice model and a partially linear choice model. Boosting the data tree structure can include applying iterative estimation of a plurality of incremental data trees, for instance.

A boosted data tree structure 210 can include an estimate of a semi-parametric utility function. A tree-based approach, such as a heuristic function, can partition products into homogeneous groups based on utility functions. The utility function within a group can be as similar as possible but between groups is different.

For instance, an initial data tree can include a representation of the relationship between the plurality of factors of the set of products. The relationship can include a semi-parametric relationship, for instance. As illustrated in FIG. 2, an example initial data tree can include four nodes 212, 214, 216, 220. A node, as used herein, can represent a data point. The data point can include a group, such as a group of products that are grouped based on utility functions. A number of node paths can show a relationship between the number of nodes (e.g., such as between the four nodes). For example, two nodes that are directly connected (e.g., connected with no nodes between the two nodes) can have a closer relationship compared to two nodes that are not directly connected (e.g., connected with a number of nodes connected between the two nodes).

The four groupings of products represented by four nodes 212, 214, 216, 220 of the initial data tree can include groupings determined using the semi-parametric choice model. For instance, the four nodes can include a root node 212 that can include the entire set of products in the market and the additional groupings 214, 216, 220. The three additional groupings 214, 216, 220 can include a utility function of products in brands 214 (e.g., products of brands A, B, C, and/or D of a computer market in Australia), a utility function of products not in the brands 216, and a utility function of products not in the brands of node 214 with a graphics processing unit (GPU) feature specified 220 (e.g., products with GPU feature I, II, and/or III).

The initial data tree can, for instance, be boosted. Boosting the initial data tree can include modeling residuals from the initial data tree and/or boosting a semi-parametric choice model, for example. The boosted data tree structure 210 can result in a data tree with additional nodes 218, 222, 224 added to the initial data tree. The additional nodes 218, 222, 224 can represent additional groupings of products based on a utility function of the groups (e.g., a group of products without GPU feature I, II, and/or III 218, a group of products with processor features a and/or b 222, and a group of products without processor features a and b 224). For instance, boosting a functional-coefficient choice model can include starting with a naïve fit of:

\hat{f}ᵢ⁽⁰⁾=x′ᵢ \hat{β},

wherein \hat{β} can be estimated with an iteratively reweighted least squares (IRLS) under a linear choice model. For example, for each b=1, . . . , B, wherein B is the number of boosting steps (e.g., iterative steps) the following process can be repeated to boost the choice model:
1.) Compute a pseudo observation using:

$${ξ}_{i} = - \frac{\partial φ}{\partial {f}_{i}} {\vert}_{f = {\hat{f}}^{( b - i )}} .$$

2.) Fit ξᵢ on sᵢ and on xᵢ using a PartReg function (e.g., as discussed herein) to obtain partitions of (Ĉ₁^{(b)}, . . . , Ĉ_{M}^{(b)}), wherein M can denote the number of terminal nodes for a single data tree. The iterative data trees can, for instance, include ordinary regression data trees and/or a varying-coefficient data trees (e.g., formed using a varying-coefficient regression model). A regressions tree can include an analysis with a predicted outcome and can be considered a real number (e.g., the price of a house).

$$Let {z}_{i} = {( {I}_{( {s}_{i} ɛ {\hat{C}}_{1}^{( b )} )} , … , {I}_{( {s}_{i} ɛ {\hat{C}}_{M}^{( b )} )} , {x}_{i} {I}_{( {s}_{i} ɛ {\hat{C}}_{1}^{( b )} )} , … , {I}_{( {s}_{i} ɛ {\hat{C}}_{M}^{( b )} )} )}^{′}$$

and apply IRLS to estimate β^{(b)} by minimizing the functional-coefficient choice model, which can be represented by:

$$J ( {β}^{( b )} ) = - 2 {\sum }_{i = 1}^{K} {n}_{i} \{ log ( g ( {\hat{f}}_{i}^{( b - 1 )} + {z}_{i}^{′} {β}^{( b )} ) ) \} + 2 N log \{ {\sum }_{i = 1}^{K} g ( {\hat{f}}_{i}^{( b - 1 )} + {z}_{i}^{′} {β}^{( b )} ) \} ,$$

and an estimated vector can be denoted by \hat{β}^{(b)}=(\hat{β}₀₁^{(b)}, . . . , \hat{β}_{0M}^{(b)}, \hat{β}₁₁^{(b)}, . . . , \hat{β}_{M}^{(b)})′.
4.) Update the fitted model (e.g., the current product demand model) by:

\hat{f}^{(b)}=\hat{f}^{(b-1)}+vΣₘ₌₁^{M}{β_{0,}^{(b)}+\hat{β}₁ₘ^{(b)} xᵢ}I₍ₛ_{ᵢ}_{εĉ}_{ₘ}_{^{(b)}}₎

wherein v can denote a learning rate. For the plurality of iterations, the fitted model (e.g., product demand model) can be updated by the output of \hat{f}=\hat{f}^{(B)}. Thereby, each regression tree can be added to the current product demand model at each iteration. The illustrated example process for boosting a functional-coefficient choice model list the process from numeral 1 through numeral 4. However, examples of the present disclosure are not so limited and the process can be performed, calculated, and/or repeated in an interchangeable order.

Alternatively and/or in addition, boosting a partially linear choice model can include starting with a naïve fit of:

\hat{f}ᵢ⁽⁰⁾=\hat{β}₀+x′ᵢ \hat{β},

wherein \hat{β}₀ and \hat{β} can be estimated with an IRLS under a linear choice model. For each b=1, . . . , B, wherein B is the number of boosting steps, the following process can be repeated to boost the partially linear choice model:
1.) Compute a pseudo observation using:

$${ξ}_{i} = - \frac{\partial J}{\partial {f}_{i}} {\vert}_{f = {\hat{f}}^{( b - i )}} .$$

2.) Fit ξᵢ on sᵢ using a CART™ function to obtain:

$${\hat{ξ}}_{i} = {\sum }_{m = 1}^{M} {\hat{ξ}}_{m}^{( b )} {I}_{( {s}_{j} {\hat{C}}_{m}^{( b )} )} .$$

A CART™ function, as used herein, can include a function to analyze a classification tree and a regression tree. A classification tree can include an analysis with a predicted outcome of a class to which the data belongs. For example, the CART™ function can use binary trees to classify and perform regressions.
3.) Let

$${z}_{i} = {( {I}_{( {s}_{i} ɛ {\hat{C}}_{1}^{( b )} )} , … , {I}_{( {s}_{i} ɛ {\hat{C}}_{M}^{( b )} )} )}^{′}$$

and estimate (γ′₀, γ′)′ by minimizing the partially linear choice model, which can be represented by:

$$J ( {γ}_{0} , γ ) = - 2 {\sum }_{i = 1}^{K} {n}_{i} \{ log ( g ( {\hat{f}}_{i}^{( b - 1 )} + {z}_{i}^{′} {γ}_{0} + {x}_{i}^{1} γ ) ) \} + 2 N log \{ {\sum }_{i = 1}^{K} g ( {\hat{f}}_{i}^{( b - 1 )} + {z}_{i}^{′} {γ}_{0} + {x}_{i}^{1} γ ) \} .$$

4.) Update the fitted model (e.g., the current product demand model) by:

$${\hat{f}}^{( b )} = {\hat{f}}^{( b - 1 )} + v {\sum }_{m = 1}^{M} {\hat{γ}}_{0 m} {I}_{( {s}_{i} ɛ {\hat{C}}_{1}^{( b )} )} + {vx}_{i}^{1} \hat{γ} ,$$

wherein v can denote a learning rate. For the plurality of iterations, the fitted model (e.g., product demand model) can be updated by the output of \hat{f}=\hat{f}^{(B)}. The illustrated example process for boosting a partially linear choice model in accordance with the present disclosure list the process from numeral 1 through numeral 4. However, examples of the present disclosure are not so limited and the process can be performed, calculated, and/or repeated in an interchangeable order.

In some examples of the present disclosure, a regression tree can be constructed and/or estimated using a varying-coefficient regression model. A varying-coefficient regression model can include a semi-parametric choice model, for example. For instance, (s′ᵢ, x′ᵢ, yᵢ) can denote measurements on product i, wherein i=1, . . . , n. A varying co-efficient variable sᵢ can include a partition variable which can be denoted by sᵢ=(sᵢ₁, sᵢ₂, . . . , s_{iq})′ and a regression variable xᵢ can be denoted by xᵢ=(xᵢ₁, xᵢ₂, . . . , xᵢₚ)′. The two sets of variables (e.g., the varying-coefficient variables sᵢ and the regression variable xᵢ) can have overlaps. For instance, the first element of xᵢ can be set to 1 to allow for an intercept term. A value of a variable to be predicted can be denoted as yᵢ=(yᵢ₁, yᵢ₂, . . . , yᵢₚ), for example.

With a varying-coefficient regression model, {Cₘ}ₘ₌₁^{M} can denote a partition of a space R^{q} satisfying Cₘ∩C_{m′}=θ for any m≠m′, and ∪ₘ₌₁^{M} C_{M}=R^{q}. The set Cₘ can be referred to as a terminal node (e.g., a leaf node), which can define the ultimate grouping of observations. Here, M can denote the number of partitions (e.g. tree nodes). The number of tree nodes can be fixed when the trees are used as base learners in boosting. A tree-based varying co-efficient regression model can include:

$${y}_{i} = {\sum }_{m = 1}^{M} {x}_{i}^{1} {β}_{m} {I}_{( {s}_{i} ɛ {C}_{m} )} + {ɛ}_{i} , \qquad ( 8 )$$

wherein J_{(·)} can denote an indicator function with I_{(c)}=1 if event c is true and zero otherwise. The error terms εᵢs can be assumed to have zero mean and homogenous variance σ².

A least squares criterion for Equation 8 can result in an estimator of (Cₘ, βₘ) as minimizers of sum squared errors (SSE), resulting in:

$$\begin{matrix}( {\hat{C}}_{m} , {\hat{β}}_{m} ) = {argmin}_{( {C}_{m} , {β}_{m} )} {\sum }_{i = 1}^{n} {( {y}_{i} - {\sum }_{m = i}^{M} {x}_{i}^{1} {β}_{m} {I}_{( {s}_{i} ɛ {C}_{m} )} )}^{2} \\ = {argmin}_{( {C}_{m} , {β}_{m} )} {\sum }_{i = 1}^{n} {\sum }_{m = 1}^{M} {( {y}_{i} - {x}_{i}^{1} {β}_{m} )}^{2} {I}_{( {s}_{i} ɛ {C}_{m} )} .\end{matrix} \qquad ( 9 )$$

In Equation 9, the estimation of βₘ can be nested in that of the partitions. SSE, as used herein, can include a measure of discrepancy between data and an estimated model. Taking the least squares estimator, which can be denoted by:

$${\hat{β}}_{m} ( {C}_{m} ) = {argmin}_{{β}_{m}} {\sum }_{i = 1}^{n} {( {y}_{i} - {x}_{i}^{1} {β}_{m} )}^{2} {I}_{( {s}_{i} ɛ {C}_{m} )} ,$$

in which the minimization criterion can be based on the observation in node Cₘ only. Thereby, regression parameters βₘ can be profiled, resulting in:

$${\hat{C}}_{m} = {argmin}_{{C}_{m}} {\sum }_{m = 1}^{M} SSE ( {C}_{m} ) := {argmin}_{{C}_{m}} {\sum }_{i = 1}^{n} {\sum }_{m = 1}^{M} {( {y}_{i} - {x}_{i}^{1} {\hat{β}}_{m} ( {C}_{m} ) )}^{2} {I}_{( {s}_{i} ɛ {C}_{m} )} , \qquad ( 10 )$$

wherein SSE(Cₘ):=arg min_{C}_{ₘ} Σᵢ₌₁ⁿ(yᵢ−x′ᵢ βₘ)² I₍ₛ_{ᵢ}_{εC}_{ₘ}₎.

The sets {Cₘ}ₘ₌₁^{M} can include an optimal partition of a space expanded by the partitioning variables s, where the optimality is with respect to the least square criterion. The search of an optimal partition can be of combinatorial complexity based on the size of the dataset. A tree-based data structure and/or model can find optimal partitioning and be scalable to large-scale datasets. A data tree (e.g., regression tree) estimated and/or calculated using a varying coefficient regression model can include a non-parametric data tree.

In various examples of the present disclosure, a regression tree can be fit using a Partitioned Regression (PartReg) function (e.g., as described herein). A PartReg function can be used at each iteration. For instance, at each iteration, a partition variable can be cycled through and all binary splits can be considered at each variable using the PartReg function. For instance, for an ordinary and/or a continuous variable, distinct values of the variable can be sorted and cuts can be placed between any two adjacent values to form partitions.

Splitting and/or cuts based on an unordered categorically variable can be difficult, particularly when there are multiple categories. The categories, in some examples of the present disclosure, can be ordered and the variable can be treated as an ordinal variable. An ordering approach can, for instance, be faster than a nonorder exhaustive search and can perform comparably to an exhaustive search when combined with boosting. A category approach can include the PartReg function and/or CART™ function. The PartReg function approach is similar to CART™ function in that the categories are ordered based on a mean response in each category and then treated as ordinal variables. This can reduce the computation complexity from exponential to lineal.

As an example, in a partitioned regression context, \hat{β}ᵢ can denote the least squares estimate of β based on observations in the I-th category. A fitted model in the I-th category can be denoted as x′\hat{β}ᵢ. A strict ordering of the hyperplanes x′\hat{β}ᵢ may not exist, for example. However, the L categories can be ordered using x̅′\hat{β}ᵢ, wherein x̅ can denote a mean vector of xᵢs in a current node, and then the categorical variable can be treated as ordinal. Such an approximation can be useful when fitted models (e.g., iterative plurality of data trees) are separated.

For instance, an iterative PartReg function can include initializing a current number of terminal nodes to l=1 and Cₘ= [symbol] ^{q}. While l<M, wherein M can denote the desired number of terminal nodes, the following process can be looped:

1. For m=1 to I and j=1 to q, repeat:
a. Consider all partitions Cₘ into C_{m,L} and C_{m,R} based on the j-th variable. The maximum reduction in SSE can be denoted by:

ΔSSE_{m,j}=max{SSE(C_{M})−SSE(C_{m,L})−SSE(C_{m,R})}, (11)

wherein the maximum can be taken over all possible partitions based on the j-th variable such that min{#C_{m,L}, #C_{m,R}}≧n₀. #C can denote the cardinality of set C and n₀ can denote the minimum number of observations in a terminal node.
b. Let ΔSSE₁=maxₘ maxⱼ ΔSSE_{m,j}, such that the maximum reduction in the sum of squared error among all candidate splits in all terminal nodes at a current stage.

2.) Let ΔSSE_{m*,j*}=ΔSSE₁, wherein the j*-th variable on the m*-th terminal node can provide the optimal partition. The m*-th terminal node can be split according to the optimal partitioning criterion and increase I by 1.

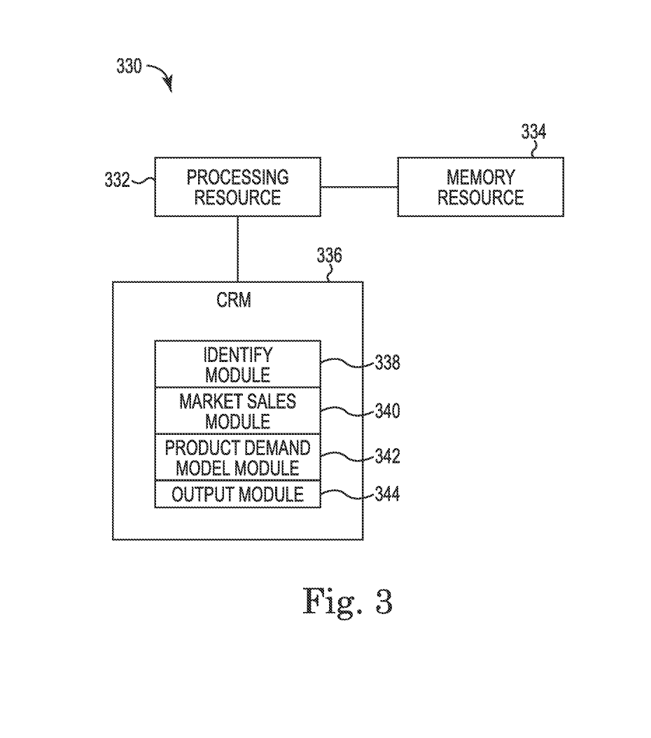

FIG. 3 is a diagram illustrating an example system 330 including a computing device according to the present disclosure. The computing device can utilize software, hardware, firmware, and/or logic. The computing device can include a computing device configured to perform the functions as described in FIG. 1 and FIG. 2.

The computing device can be any combination of hardware and program instructions configured to select a desired data path. The hardware, for example can include one or more processing resources 332, computer-readable medium (CRM) 336 (e.g., machine-readable medium, database, etc.). The program instructions (e.g., computer-readable instructions (CRI)) can include instructions stored on the CRM 336 and executable by the processing resources 332 to implement a desired function (e.g., identify a set of products from input aggregated market sales data, analyze the aggregated market sales data to determine a semi-parametric relationship between a plurality of factors of the set of products, etc.).

CRM 336 can be in communication with a number of processing resources of more or fewer than 332. The processing resources 332 can be in communication with a tangible non-transitory CRM 336 storing a set of CRI executable by one or more of the processing resources 332, as described herein. The CRI can also be stored in remote memory managed by a server and represent an installation package that can be downloaded, installed, and executed. The computing device can include a memory resource 334, and the processing resources 332 can be coupled to the memory resource 334.

Processing resources 332 can execute CRI that can be stored on an internal or external non-transitory CRM 336. The processing resources 332 can execute CRI to perform various functions, including the functions described in FIG. 1 and FIG. 2. For example, the processing resources 332 can execute CRI to identify a set of products from input aggregated market sales data.

The CRI can include a number of modules 338, 340, 342, 344. The number of modules 338, 340, 342, 344 can include CR1 that when executed by the processing resources 332 can perform a number of functions.

The number of modules 338, 340, 342, 344 can be sub-modules of other modules. For example, the market sales module 340 and the product demand module 342 can be sub-modules and/or contained within the same computing device. In another example, the number of modules 338, 340, 342, 344 can comprise individual modules on separate and distinct computing devices.

An identify module 338 can include CRI that when executed by the processing resources 332 can perform a number of functions. The identify module 338 can identify a set of products from input aggregated market sales data. The input aggregated market sales data can include input of applicable markets and an offer set in the market (e.g., set of products in the applicable markets and the set of products factors).

A market sales module 340 can include CRI that when executed by the processing resources 332 can perform a number of functions. The market sales module 340 can remove a product in the set of products below a threshold number of sales to create a revised set of products and analyze the market sales data to determine a semi-parametric relationship between the plurality of factors of the revised set of products. The revised set can include the set of products with the product with below a threshold number of sales removed from the set. The threshold number of sales can include a numerical number of sales. A product below the threshold number of sales can, for instance, be removed from the set of products (e.g., to create the revised set of products to be analyzed). A semi-parametric relationship can be determined using a partially linear choice model, for example

A product demand model module 342 can include CRI that when executed by the processing resources 332 can perform a number of functions. The product demand model module 342 can estimate the semi-parametric product demand model of the set of products using the determined semi-parametric relationship and an iterative estimation of a plurality of incremental non-parametric data trees. The determined relationship and estimated product demand module can be determined and/or estimated using a suite of semi-parametric choice models (e.g., semi-parametric models such as the functional-coefficient choice model, the partially linear choice model, and/or the varying coefficient regression model).

In some examples of the present disclosure, the product demand model module 342 can further include CRI that when executed by the processing resources 332 can output an estimate of a customer valuation of the set of products using the estimated semi-parametric product demand model. The customer valuation can include a product-specific utility function, a brand value calculation, price sensitivity, and/or rankings of attributes of the set of products. For instance, the customer valuation can be used to determine a change to demand of a product in the set of products in response to a change of price and/or attributes of the product. The rankings of attributes can, for instance, include a determined importance of each of a number of attributes among the plurality of factors based on the estimated semi-parametric product demand module.

As illustrated by the example of FIG. 3, the system 330 can include an output module 344. The output module 344 can be a sub-module of the product demand model module 342 and/or can comprise an individual module on a separate and distinct computing device. The output module 344 can include CRI that when executed by the processing resources 332 can output the estimate of a customer valuation of the set of products. The customer valuation can include a product-specific utility function, a brand value calculation, price sensitivity, and/or rankings of attributes of the set of products.

For instance, a product-specific utility function can include a demand simulator. A user (e.g., marketing manger and/or person associated with an entity) can change a factor of a product in the set of products and/or enter a new product with new factors to observe changes in demand for the product. Observing changes in demand for the product can include observing changes of choice share based on the estimated semi-parametric product demand model. Factors that can be changed by a user can include price and/or attributes, among other factors. The factors can be manually changed by the user, for instance.

Ranking the attributes of the set of products can, for instance, include creating a chart. The chart, in some examples, can include a bar chart, a pie chart, and/or an isotherm chart, among many other types of charts. The chart can represent the importance of attributes in customer's purchase decisions. For instance, an isotherm chart of the ranking of attributes can include a line connecting attributes of equal importance.

In some embodiments, the output module 344 can comprise a plurality of individual modules on separate and distinct computing devices. For instance, the individual modules can include a demand simulator module, brand value module, a price sensitivity module, and/or an attribute ranking module, among many other output modules.

In various examples of the present disclosure, the product demand model module 342 can further include CRI that when executed by the processing resources 332 can validate the estimated semi-parametric product demand model using a validation data set. For instance, the estimated semi-parametric product demand model can be compared to a known data set to determine the model's accuracy and/or validated against other methods.

A non-transitory CRM 336, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory, and/or a solid state drive (SSD), etc., as well as other types of computer-readable media.

The non-transitory CRM 336 can be integral, or communicatively coupled, to a computing device, in a wired and/or a wireless manner. For example, the non-transitory CRM 336 can be an internal memory, a portable memory, a portable disk, or a memory associated with another computing resource (e.g., enabling MRIs to be transferred and/or executed across a network such as the Internet).

The CRM 336 can be in communication with the processing resources 332 via a communication path 346. The communication path 346 can be local or remote to a machine (e.g., a computer) associated with the processing resources 332. Examples of a local communication path 346 can include an electronic bus internal to a machine (e.g., a computer) where the CRM 336 is one of volatile, non-volatile, fixed, and/or removable storage medium in communication with the processing resources 332 via the electronic bus.

The communication path 346 can be such that the CRM 336 is remote from the processing resources (e.g., 332), such as in a network connection between the CRM 336 and the processing resources (e.g., 332). That is, the communication path 346 can be a network connection. Examples of such a network connection can include a local area network (LAN), wide area network (WAN), personal area network (PAN), and the Internet, among others. In such examples, the CRM 336 can be associated with a first computing device and the processing resources 332 can be associated with a second computing device (e.g., a Java® server). For example, a processing resource 332 can be in communication with a CRM 336, wherein the CRM 336 includes a set of instructions and wherein the processing resource 332 is designed to carry out the set of instructions.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

As used herein, “a” or “a number of” something can refer to one or more such things. For example, “a number of nodes” can refer to one or more nodes.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A computer-implemented method for estimating a semi-parametric product demand model, comprising:
identifying a set of products from input market sales data;
analyzing the market sales data to determine a relationship between a plurality of factors of the set of products; and
estimating a semi-parametric product demand model based on the determined relationship using iterative estimation of a plurality of incremental data trees.

2. The method of claim 1, wherein estimating the semi-parametric product demand model includes using a semi-parametric choice model.

3. The method of claim 1, wherein each of the plurality of incremental data trees are iteratively estimated using a varying-coefficient regression model.

4. The method of claim 1, wherein determining the relationship includes estimating a multinomial logit model using the plurality of factors.

5. The method of claim 1, wherein estimating the semi-parametric product demand model includes using a combination of the plurality of incremental data trees representing non-linear interactions between factors of the set of products.

6. The method of claim 1, wherein analyzing the market sales data includes determining a product in the set of products below a threshold sales volume and removing the determined product from the set of products.

7. A non-transitory computer-readable medium storing a set of instructions executable by a processing resource to:
identify a set of products from input aggregated market sales data;
analyze the market sales data to determine a relationship between a plurality of factors of the set of products; and
estimate a semi-parametric product demand model based on the determined relationship using iterative estimation of a plurality of incremental non-parametric data trees.

8. The non-transitory computer-readable medium of claim 7, wherein the instructions executable to use iterative estimation of a plurality of incremental non-parametric data trees are executable to, for each iteration:
calculate a number of residuals from a current product demand model;
fit a non-parametric regression tree to predict the number of residuals; and
add the non-parametric regression tree to the current product demand model to estimate the semi-parametric product demand model.

9. The non-transitory computer-readable medium of claim 7, wherein the instructions are executable to validate the estimated semi-parametric product demand model using a validation data set.

10. The non-transitory computer-readable medium of claim 7, wherein the instructions are executable to determine an importance of a number of attributes among the plurality of factors based on the estimated semi-parametric product demand model.

11. A system for estimating a semi-parametric product demand model, comprising:
a memory resource; and
a processing resource coupled to the memory resource to implement:
an identify module including computer-readable instructions stored on the memory resource and executable by the processing resource to identify a set of products from input aggregated market sales data;
a market sales module including computer-readable instructions stored on the memory resource and executable by the processing resource to analyze the market sales data to:
remove a product in the set of products below a threshold number of sales to create a revised set of products; and
analyze the market sales data to determine a semi-parametric relationship between a plurality of factors of the revised set of products; and
a product demand model module including computer-readable instructions stored on the memory resource and executable by the processing resource to estimate the semi-parametric product demand model using the determined semi-parametric relationship and an iterative estimation of a plurality of non-parametric incremental data trees.

12. The system of claim 11, wherein the market sales module includes instructions to determine the semi-parametric relationship between the plurality of factors of the set of products using a partially linear choice model.

13. The system of claim 11, wherein the product demand module includes instructions to determine a change to demand of a product in the set of products in response to a change of a factor of the product using the estimated semi-parametric product demand model.

14. The system of claim 11, wherein the product demand module includes instructions to output an estimate of customer valuation of the set of products using the estimated semi-parametric product demand model.

15. The system of claim 14, wherein customer valuation includes a product-specific utility function, brand value calculation, price sensitivity, and ranking of attributes of the set of products.
